(19) United States
(12) Patent Application Publication
(10) Pub. No.: US 2016/0090539 A1
(43) Pub. Date: Mar. 31, 2016

(54) FCC UNITS, APPARATUSES AND METHODS FOR PROCESSING PYROLYSIS OIL AND HYDROCARBON STREAMS

(71) Applicant: UOP LLC, Des Plaines, IL (US)

(72) Inventors: Stanley Joseph Frey, Palatine, IL (US); Weikai Gu, Mt. Prospect, IL (US)

(21) Appl. No.: 14/502,826

(22) Filed: Sep. 30, 2014

(51) Int. Cl. C10G 11/18; B01J 8/18; C10L 1/04

(52) U.S. Cl. CPC C10G 11/182; C10L 1/04; B01J 8/1836; C10L 2200/0469; B01J 2208/00176; B01J 2208/00902

(57) ABSTRACT

Fluid catalytic cracking (FCC) units, apparatuses, and methods for catalytically cracking a mixture of a pyrolysis oil stream and a hydrocarbon stream are provided herein. In an embodiment, an FCC unit includes a reaction chamber suitable for contacting a pyrolysis oil, a hydrocarbon, and a catalyst. The FCC unit includes a coolant conduit having an coolant outlet in communication with the reaction chamber and suitable for introducing a coolant stream through the coolant outlet into the reaction chamber. The FCC unit further includes a pyrolysis oil conduit including a pyrolysis oil outlet positioned within the coolant conduit and suitable for injecting the pyrolysis oil through the pyrolysis oil outlet into the reaction chamber.

### TECHNICAL FIELD

The technical field generally relates to apparatuses and methods for processing pyrolysis oil and hydrocarbon streams. More particularly, the technical field relates to fluid catalytic cracking (FCC) units, apparatuses, and methods for catalytically cracking a mixture of a pyrolysis oil stream and a hydrocarbon stream.

### BACKGROUND

Fluid catalytic cracking (FCC) is a well-known process for the conversion of relatively high boiling point hydrocarbons to lower boiling point hydrocarbons in the heating oil or gasoline range. Such processes are commonly referred to in the art as “upgrading” processes. To conduct FCC processes, FCC units are generally provided with one or more reaction zones where a relatively high boiling point hydrocarbon stream is contacted with a particulate cracking catalyst. The particulate cracking catalyst is maintained in a fluidized state under conditions that are suitable for the conversion of the relatively high boiling point hydrocarbons to lower boiling point hydrocarbons.

While hydrocarbon streams such as vacuum gas oil, reduced crude, or other petroleum-based sources of hydrocarbons have commonly been upgraded through FCC processes, there is a general desire to upgrade biofuels along with the hydrocarbon streams in the FCC processes. By upgrading biofuel along with the hydrocarbon streams, the resulting upgraded fuel includes a renewable content and enables net petroleum-based hydrocarbon content of the upgraded fuel to be decreased.

Biofuels encompass various types of combustible fuels that are derived from organic biomass, and one particular type of biofuel is pyrolysis oil, which is also commonly referred to as biomass-derived pyrolysis oil. Pyrolysis oil is produced through pyrolysis, including through fast pyrolysis processes. Fast pyrolysis is a process during which organic biomass, such as wood waste, agricultural waste, etc., is rapidly heated to from about 450° C. to about 600° C. in the absence of air using a pyrolysis unit. Under these conditions, a pyrolysis vapor stream including organic vapors, water vapor, and pyrolysis gases is produced, along with char (which includes ash and combustible hydrocarbon solids). A portion of the pyrolysis vapor stream is condensed in a condensing system to produce a liquid pyrolysis oil stream. Pyrolysis oil is a complex, highly oxygenated organic liquid that typically contains about 20-30% by weight water with high acidity (TAN>150).

Due to the high oxygen content of the pyrolysis oils, pyrolysis oils are generally immiscible with hydrocarbon streams. Prior attempts to co-process pyrolysis oil streams and hydrocarbon streams have involved deoxygenation of the pyrolysis oil followed by combining the deoxygenated pyrolysis oil stream and the hydrocarbon stream prior to FCC processing. Such approaches add unit operations, along with added capital costs, to the upgrading process. Further, even after deoxygenating the pyrolysis oils, pyrolysis oil feed lines may become clogged due to polymerization of the pyrolysis oils, and pyrolysis oil feed lines that facilitate introduction of a pyrolysis oil stream into a reaction zone where FCC processing is conducted are particularly prone to clogging. Additionally, feed lines that contain mixtures of a hydrocarbon stream and a pyrolysis oil stream are also generally prone to clogging due to the presence of the pyrolysis oil stream in the feed lines. Simply separating and introducing the hydrocarbon stream and the pyrolysis oil stream into the reaction zone through separate feed lines is ineffective to avoid clogging.

Accordingly, it is desirable to provide FCC units, apparatuses, or methods for processing pyrolysis oil stream that minimize clogging in feed lines. Further, it is desirable to provide FCC units, apparatuses, or methods for catalytically cracking a mixture of a pyrolysis oil stream and a hydrocarbon stream. Furthermore, other desirable features and characteristics will become apparent from the subsequent detailed description and the appended claims, taken in conjunction with the accompanying drawings and this background.

### BRIEF SUMMARY

Fluid catalytic cracking (FCC) units, apparatuses, and methods for catalytically cracking a mixture of a pyrolysis oil stream and a hydrocarbon stream are provided herein. In an embodiment, a fluid catalytic cracking unit includes a reaction chamber suitable for contacting a pyrolysis oil, a hydrocarbon, and a catalyst. The FCC unit includes a coolant conduit having a coolant outlet in communication with the reaction chamber and suitable for introducing a coolant stream through the coolant outlet into the reaction chamber. The FCC unit further includes a pyrolysis oil conduit including a pyrolysis oil outlet positioned within the coolant conduit and suitable for injecting the pyrolysis oil through the pyrolysis oil outlet into the reaction chamber.

In another embodiment, a fuel processing apparatus is provided. The fuel processing apparatus includes a pyrolysis reactor for pyrolyzing a biomass stream to produce a pyrolysis oil and a fluid catalytic cracking unit. The fluid catalytic cracking unit includes a reaction chamber suitable for contacting the pyrolysis oil, a hydrocarbon, and a catalyst. The fluid catalytic cracking unit also includes a hydrocarbon conduit in fluid communication with the reaction chamber and suitable for introducing the hydrocarbon into the reaction chamber. The fluid catalytic cracking unit also includes an annular pipe having an outer coolant conduit and an inner pyrolysis oil conduit positioned within the outer coolant conduit. The outer coolant conduit is in communication with the reaction chamber and is suitable for introducing a coolant into the reaction chamber in a coolant stream. The inner pyrolysis oil conduit is suitable for injecting the pyrolysis oil into the coolant stream within the reaction chamber.

In another embodiment, a method for processing a pyrolysis oil stream and a hydrocarbon stream is provided. The method includes introducing the hydrocarbon stream to a reaction zone. In the method, a stream of coolant is introduced into contact with the hydrocarbon stream within the reaction zone. The method further includes injecting the pyrolysis oil stream into the stream of coolant within the reaction zone.

### BRIEF DESCRIPTION OF THE DRAWINGS

The various embodiments will hereinafter be described in conjunction with the following drawing figures, wherein like numerals denote like elements, and wherein:

FIG. 1 is a schematic diagram of an apparatus and a method for processing pyrolysis oil and hydrocarbon streams in accordance with an exemplary embodiment;

FIG. 2 is a schematic diagram of a portion of the schematic diagram of FIG. 1 showing an embodiment of a pyrolysis oil feed line in greater detail; and

FIG. 3 is a schematic diagram of an alternate embodiment of a pyrolysis feed line.

### DETAILED DESCRIPTION

The following detailed description is merely exemplary in nature and is not intended to limit the FCC units, apparatuses, and methods for processing pyrolysis oil and hydrocarbon streams. Furthermore, there is no intention to be bound by any theory presented in the preceding background or the following detailed description.

FCC units, apparatuses and methods for processing pyrolysis oil and hydrocarbon streams are provided herein. In exemplary embodiments, the processing involves upgrading the pyrolysis oil stream and the hydrocarbon stream. As referred to herein, “upgrading” refers to conversion of relatively high boiling point hydrocarbons to lower boiling point hydrocarbons. Upgrading processes generally render the hydrocarbon stream and the pyrolysis oil stream suitable for use as a transportation fuel. In the methods and fuel processing apparatuses described herein, a mixture of the pyrolysis oil stream and the hydrocarbon stream are catalytically cracked in a reaction zone in the presence of a particulate cracking catalyst. The reaction zone, as referred to herein, is an area or space where particulate cracking catalyst is comingled along with the pyrolysis oil stream and/or the hydrocarbon stream.

Catalytic cracking is conducted at temperatures in excess of 160° C., and the hydrocarbon stream is generally provided at temperatures in excess of 160° C. However, pyrolysis oil generally polymerizes at temperatures in excess of about 160° C. and forms deposits within the fuel processing apparatuses. Deposit formation is less of a concern in the reaction zone than in feed lines that lead to the reaction zone. In particular, deposit formation in the reaction zone generally results in deposited compounds forming on the particulate cracking catalyst. Because the particulate cracking catalyst may be regenerated through conventional processes even with high amounts of deposited compounds present thereon, operation of the fuel processing apparatuses is not materially affected by formation of deposited compounds on the particulate cracking catalyst. However, deposit formation in the feed lines that lead to the reaction zone may result in clogging, which requires shutdown of the fuel processing apparatuses and cleanout of the clogged feed lines. Therefore, to minimize deposit formation attributable to polymerization within the pyrolysis oil stream in the feed lines that lead to the reaction zone, the methods and apparatuses that are described herein are adapted to minimize temperature rise of the pyrolysis oil stream until the pyrolysis oil stream is clear of structure upon which deposit formation could cause clogging.

To minimize the temperature rise of the pyrolysis oil stream in accordance with embodiments described herein, the pyrolysis oil stream and the hydrocarbon stream are separately introduced into the reaction zone, optionally in the presence of a carrier gas. In exemplary embodiments, the pyrolysis oil stream is maintained at a temperature of less than or equal to about 160° C. substantially up to introduction into the reaction zone. Without being bound by any particular theory, it is believed that a temperature rise in the pyrolysis oil stream above about 160° C. results in excessive deposit formation due to polymerization within the pyrolysis oil stream. By maintaining the temperature of the pyrolysis oil stream at the temperature of less than or equal to about 160° C. substantially up to introduction into the reaction zone, deposit formation prior to introducing the pyrolysis oil stream into the reaction zone is minimized at least while the pyrolysis oil stream is in contact with structures within the fuel processing apparatuses outside of the reaction zone, where deposit formation could cause clogging.

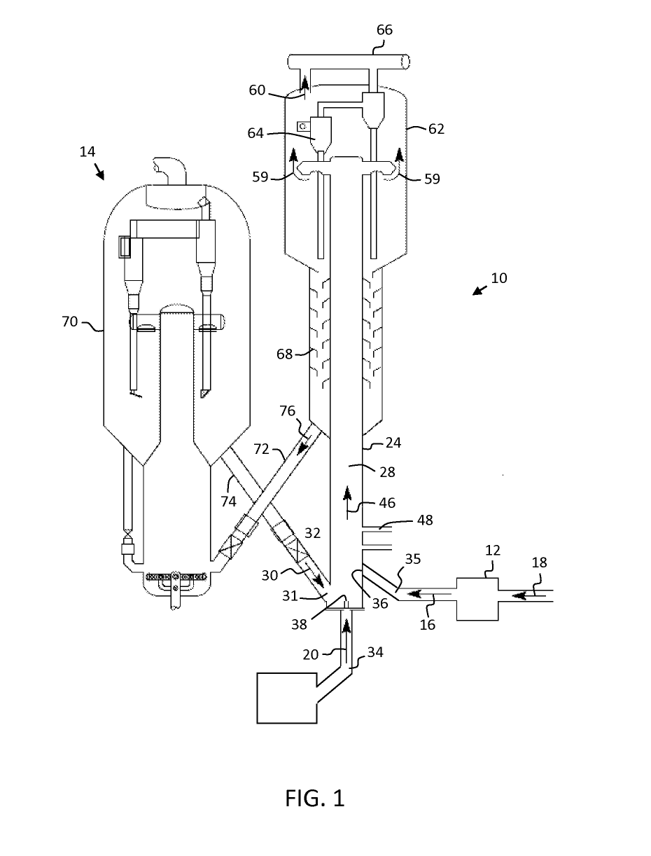

An exemplary embodiment of a method for processing a pyrolysis oil stream and a hydrocarbon stream will now be addressed with reference to an exemplary fuel processing apparatus 10 as shown in FIG. 1. In this embodiment, the fuel processing apparatus 10 includes a pyrolysis unit 12 and a fluid catalytic cracking (FCC) unit 14. The pyrolysis unit 12 provides a pyrolysis oil stream 16. In an exemplary embodiment, the pyrolysis unit 12 pyrolyzes a biomass stream 18 to produce the pyrolysis oil stream 16, such as through fast pyrolysis. Fast pyrolysis is a process during which the biomass stream 18, such as wood waste, agricultural waste, biomass that is purposely grown and harvested for energy, and the like, is rapidly heated to from about 450° C. to about 600° C. in the absence of air in the pyrolysis unit 12. Under these conditions, a pyrolysis vapor stream (not shown) including organic vapors, water vapor, and pyrolysis gases is produced, along with char (which includes ash and combustible hydrocarbon solids). A portion of the pyrolysis vapor stream is condensed in a condensing system (not shown) within the pyrolysis unit 12 to produce the pyrolysis oil stream 16. The pyrolysis oil stream 16 is a complex, organic liquid having an oxygen content, and may also contain water. For example, the oxygen content of the pyrolysis oil stream 16 can be from about 30 to about 60 weight %, such as from about 40 to about 55 weight %, based on the total weight of the pyrolysis oil stream 16. Water can be present in the pyrolysis oil stream 16 in an amount of from about 10 to about 35 weight %, such as from about 20 to about 32 weight %, based on the total weight of the pyrolysis oil stream 16.

It is to be appreciated that in other embodiments, the pyrolysis oil stream 16 may be provided by any source such as a vessel that contains the pyrolysis oil stream 16, and the methods described herein are not limited to providing the pyrolysis oil stream 16 from any particular source. In an embodiment, the pyrolysis oil stream 16 is provided from the pyrolysis unit 12 at a temperature of less than or equal to about 50° C., such as less than or equal to about 30° C., to minimize polymerization of the pyrolysis oil stream 16 that could lead to deposit formation after leaving the pyrolysis unit 12.

The exemplary FCC unit 14 includes a reaction zone or chamber 28. As shown, the pyrolysis oil stream 16 is introduced into the reaction zone 28 of the FCC unit 14. In accordance with exemplary embodiments, the pyrolysis oil stream 16 is introduced into the reaction zone 28 in the absence of intervening upgrading processing of the pyrolysis oil stream 16. Intervening upgrading processes include, but are not limited to, deoxygenation, cracking, hydrotreating, and the like. In an embodiment, the pyrolysis oil stream 16 is provided directly as a condensed product stream from the pyrolysis unit 12.

In accordance with exemplary embodiments contemplated herein, a hydrocarbon stream 20 is also provided. As referred to herein, “hydrocarbon stream” refers to a petroleum-based source of hydrocarbons. The hydrocarbon stream 20 is provided separately from the pyrolysis oil stream 16, such that the pyrolysis oil stream 16 and hydrocarbon stream 20 are separately introduced into the reaction zone 28, as described in further detail below. The hydrocarbon stream 20 can include a fresh stream of hydrocarbons, or can include a refined stream of hydrocarbons from other refinement operations. In an embodiment, the hydrocarbon stream 20 is vacuum gas oil, which is a common hydrocarbon stream 20 that is upgraded in FCC units. It is to be appreciated that the hydrocarbon stream 20 may be provided from any source, and the methods described herein are not limited to providing the hydrocarbon stream 20 from any particular source. In embodiments, the hydrocarbon stream 20 is provided at a temperature that is higher than the pyrolysis oil stream 16, and is introduced into the reaction zone 28 at a temperature that is higher than the pyrolysis oil stream 16, because little risk of deposit formation from the hydrocarbon stream 20 exists at elevated temperatures and because elevated temperatures of the hydrocarbon stream 20 promote catalytic cracking. In an embodiment, the hydrocarbon stream 20 is provided at a temperature of at least 100° C., such as from about 100 to about 425° C., for example from about 200 to about 300° C.

Referring again to FIG. 1, the exemplary FCC unit 14 includes a hydrocarbon feed line 34 and a pyrolysis oil feed line 35. The pyrolysis oil feed line 35 has a pyrolysis oil outlet 36 in fluid communication with the reaction zone 28 for introducing the pyrolysis oil stream 16 into the reaction zone 28. While the pyrolysis oil feed line 35 is illustrated as interconnecting the pyrolysis unit 12 and the FCC unit 14, it is envisioned that the pyrolysis oil stream 16 be produced at the pyrolysis unit 12 and stored or transported for later processing at the FCC unit 14. The hydrocarbon feed line 34 has a hydrocarbon outlet 38 in the reaction zone 28 for introducing the hydrocarbon stream 20 into the reaction zone 28 separate from the pyrolysis oil stream 16. An exemplary method separately introduces the pyrolysis oil stream 16 and the hydrocarbon stream 20 into the reaction zone 28 to form a mixture 46 of the pyrolysis oil stream 16 and the hydrocarbon stream 20 in the reaction zone 28. By separately introducing the pyrolysis oil stream 16 and the hydrocarbon stream 20 into the reaction zone 28, a temperature rise of the pyrolysis oil stream 16 can be controlled and a temperature of the pyrolysis oil stream 16 can be maintained at less than or equal to about 160° C., such as less than or equal to about 80° C., substantially up to introduction into the reaction zone 28, e.g., substantially up to the pyrolysis oil outlet 36 into the reaction zone 28. At the same time, the temperature of the hydrocarbon stream 20 may be maintained at a desired elevated temperature in the range noted above.

It is to be appreciated that a slight temperature rise above the aforementioned values is permissible, even prior to pyrolysis oil stream 16 passing through the pyrolysis oil outlet 36, so long as the temperature of the pyrolysis oil stream 16 is maintained at less than or equal to about 160° C. substantially up to introduction into the reaction zone 28. In an embodiment, the temperature of the pyrolysis oil stream 16 is maintained at less than or equal to about 160° C. by actively cooling the pyrolysis oil stream 16. Active cooling, as referred to herein, means that the pyrolysis oil stream 16 is cooled by a controllable cooling activity that enables a magnitude of cooling to be increased or decreased as opposed to insulating the pyrolysis oil stream 16 using insulation alone.

The exemplary FCC unit 14 is further provided with a regenerated catalyst feed line 32 through which a cracking catalyst 30, such as a particulate cracking catalyst, may flow into the reaction zone 28. As shown, the regenerated catalyst feed line 32 has a catalyst outlet 31 in fluid communication with the reaction zone 28. The reaction zone 28 is configured to contact the particulate cracking catalyst 30 with the mixture 46 of the hydrocarbon stream 20 and the pyrolysis oil stream 16. The regenerated catalyst that supplies most of the heat for the reaction enters the reactor 36 via line 32 at point 31. The regenerated catalyst is typically between 590° C. and 750° C.

The exemplary method catalytically cracks the mixture 46 of the pyrolysis oil stream 16 and the hydrocarbon stream 20 in the presence of the particulate cracking catalyst 30. In this regard, the particulate cracking catalyst 30 can first contact one of the hydrocarbon stream 20 or the pyrolysis oil stream 16 before contacting the other of the hydrocarbon stream 20 or the pyrolysis oil stream 16. Because the particulate cracking catalyst 30 is generally introduced into the reaction zone 28 at a temperature that is sufficient to facilitate catalytic cracking of the mixture 46 of the pyrolysis oil stream 16 and the hydrocarbon stream 20, catalytic cracking generally commences when the particulate cracking catalyst 30 is comingled with the hydrocarbon stream 20.

In an exemplary embodiment and as shown in FIG. 1, the reaction zone 28 of the FCC unit 14 is included in a vertical conduit or riser 24. In an embodiment, catalytically cracking the mixture 46 of the pyrolysis oil stream 16 and the hydrocarbon stream 20 includes comingling the particulate cracking catalyst 30 and the pyrolysis oil stream 16 and/or the hydrocarbon stream 20 in the reaction zone 28. For example, in an embodiment and as shown in FIG. 1, the hydrocarbon stream 20 is introduced into the riser 24 from the hydrocarbon outlet 38 at a nearer location to the catalyst outlet 31 than the pyrolysis oil outlet 36. In this embodiment, the particulate cracking catalyst 30 may be introduced into the reaction zone 28 at the catalyst outlet 31 positioned nearer the hydrocarbon outlet 38 than the pyrolysis oil outlet 36, resulting in the particulate cracking catalyst 30 first comingling with the hydrocarbon stream 20 before formation of the mixture 46 in the reaction zone 28. Such configuration of the hydrocarbon outlet 38, the catalyst outlet 31, and the pyrolysis oil outlet 36 may enable reaction temperatures within the reaction zone 28 to be expediently optimized before introducing the relatively cool pyrolysis oil stream 16 into the reaction zone 28. However, it is to be appreciated that the methods described herein are not particularly limited to the relative locations of the hydrocarbon outlet 38, the catalyst outlet 31, and the pyrolysis oil outlet 36 and that any relative location of the hydrocarbon outlet 38, the catalyst outlet 31, and the pyrolysis oil outlet 36, whether upstream, downstream, or at evenstream from each other, is feasible in accordance with embodiments described herein.

In an embodiment and as shown in FIG. 1, the pyrolysis oil stream 16 is introduced into the reaction zone 28 angled in line with the vertical direction of flow within the riser 24 to minimize contact of the pyrolysis oil stream 16 with the walls of the riser 24, thereby minimizing deposit formation on the walls of the riser 24 attributable to the pyrolysis oil stream 16. The residence time of the particulate cracking catalyst 30 and the mixture 46 of the pyrolysis oil stream 16 and the hydrocarbon stream 20 in the riser 24 is generally only a few seconds. Conventional operating conditions for the reaction zone 28 in FCC units may be employed.

Catalytic cracking of the mixture 46 of the pyrolysis oil stream 16 and the hydrocarbon stream 20 produces an effluent 59 that includes spent particulate cracking catalyst 76 and a gaseous component 60. The gaseous component 60 includes products from the reaction in the reaction zone 28 such as cracked hydrocarbons, and the cracked hydrocarbons may be condensed to obtain upgraded fuel products that have a range of boiling points. Examples of upgraded fuel products include, but are not limited to, propane, butane, naphtha, light cycle oil, and heavy fuel oil.

In accordance with an exemplary embodiment, the spent particulate cracking catalyst 76 and the gaseous component 60 are separated. As shown in FIG. 1, the FCC unit 14 further includes a separator vessel 62 that is in fluid communication with the reaction zone 28. The separator vessel 62 separates the spent particulate cracking catalyst 76 from the effluent 59. The separator vessel 62 may include a solids-vapor separation device 64. As is typical, the exemplary solids-vapor separation device 64 is located within and at the top of the separator vessel 62. The gaseous component 60 of the effluent 59 is separated from the spent particulate cracking catalyst 76 in the separator vessel 62, and the gaseous component 60 may be vented from the separator vessel 62 via a product line 66. Although not shown, the gaseous component 60 may be compressed to obtain the upgraded fuel products, and FCC product gas that is not condensed may be recycled for use as a coolant and/or carrier gas in certain embodiments. In an embodiment, the spent particulate cracking catalyst 76 falls downward to a stripper 68 that is located in a lower part of the separator vessel 62. The stripper 68 assists with removing deposited compounds from the spent particulate cracking catalyst 76 prior to further catalyst regeneration.

In an embodiment, the FCC unit 14 further includes a catalyst regenerator 70 that is in fluid communication with the separator vessel 62 and that is also in fluid communication with the reaction zone 28. The spent particulate cracking catalyst 76 that is separated from the gaseous component 60 is introduced into the catalyst regenerator 70 from the stripper 68, and deposited compounds are removed from the spent particulate cracking catalyst 76 in the catalyst regenerator 70 by contacting the spent particulate cracking catalyst 76 with oxygen-containing regeneration gas. In one embodiment, the spent particulate cracking catalyst 76 is transferred to the catalyst regenerator 70 by way of a first transfer line 72 connected between the catalyst regenerator 70 and the stripper 68. Furthermore, the catalyst regenerator 70, being in fluid communication with the reaction zone 28, passes regenerated particulate catalyst 30 to the reaction zone 28 through a second transfer line 74. In the FCC unit 14 as illustrated in FIG. 1, the particulate cracking catalyst 30 is continuously circulated from the reaction zone 28 to the catalyst regenerator 70 and then again to the reaction zone 28, such as through the second transfer line 74.

As stated above, separate introduction of the pyrolysis oil stream 16 and the hydrocarbon stream 20 into the reaction zone 28 provides for control of the temperature rise of the pyrolysis oil stream 16 substantially up to the pyrolysis oil outlet 36 into the reaction zone 28. In this regard, the pyrolysis oil feed line 35 is adapted to cool and may insulate the pyrolysis oil stream 16 from external heating while flowing through the pyrolysis oil feed line 35.

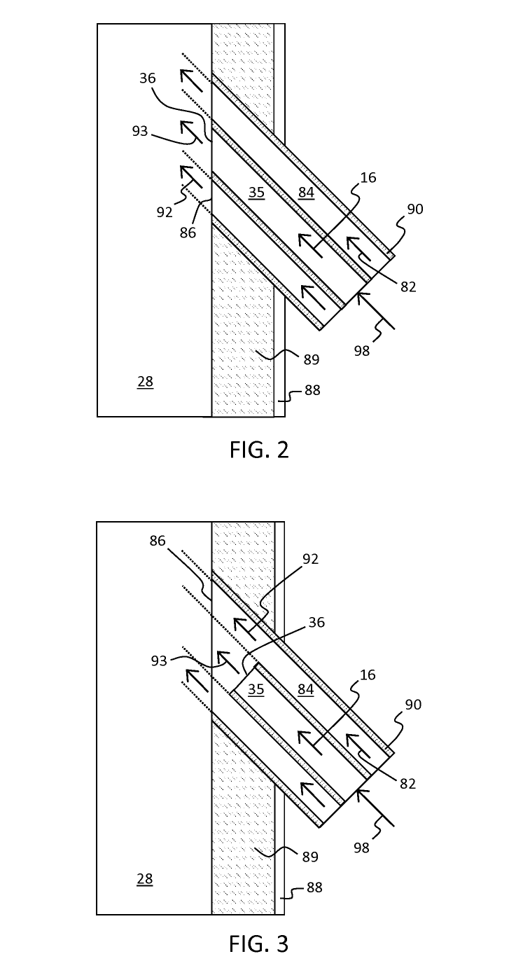

FIG. 2 illustrates an exemplary embodiment for cooling the pyrolysis oil stream 16 in the pyrolysis oil feed line 35. Specifically, the pyrolysis oil stream 16 is externally cooled with an external cooling medium or coolant 82. The exemplary coolant 82 may be a liquid or a gas. As an example, steam or FCC product gas (such as from gaseous component 60 in FIG. 1) may be utilized as the coolant 82. As shown, the coolant 82 flows through a coolant conduit 84. The coolant conduit 84 terminates at a coolant outlet 86 that is positioned inside a vessel wall 88 bounding the reaction zone 28, such as a riser wall. As shown, the vessel chamber 28 is insulated with interior refractory lining 89, such as ceramic insulation. In an exemplary embodiment, the coolant outlet 86 is flush with the inner surface of the interior refractory lining 89, i.e., the coolant conduit 84 does not extend through and out of the interior refractory lining 89, as shown in FIG. 2.

In the exemplary embodiment of FIG. 2, the pyrolysis oil feed line or conduit 35 is positioned within the coolant conduit 84. Specifically, a pipe 90 includes an outer annular portion through which the coolant 82 flows and an inner portion through which the pyrolysis oil flows. The exemplary pyrolysis oil feed line 35 has an outer diameter that is less than the inner diameter of the coolant conduit 84. The outer annular portion of the pipe 90 surrounds the inner pyrolysis oil feed line 35. As shown, the exemplary pyrolysis oil feed line 35 terminates at the pyrolysis oil outlet 36. In an exemplary embodiment, the pyrolysis oil outlet 36 is formed as an injection nozzle for spraying or atomizing the pyrolysis oil stream 16 into the reaction zone 28. The pyrolysis oil feed line 35 passes through the vessel wall 88 (within the coolant conduit 84). The exemplary pyrolysis oil outlet 36 is flush with the inner surface of the interior refractory lining 89, i.e., the pyrolysis oil feed line 35 does not extend through and out of the interior refractory lining 89, as shown in FIG. 2.

With the structure described in FIG. 2 and without being bound by any particular theory, it is believed that the coolant 82 may be injected into the reaction chamber 28 in the form of an annular stream 92. Accordingly, the pyrolysis oil stream 16 may be injected into the annular stream 92 of the coolant 82 within the reaction chamber 28 as indicated by arrows 93. It is believed that the annular stream 92 sheathes the injected pyrolysis oil 93 to delay contact with, and heat transfer from, the hydrocarbon stream in the reaction zone 28. However, the structure and function of the fuel processing apparatus is not limited to any particular flow dynamics of the coolant 82 and pyrolysis oil stream 16.

FIG. 3 illustrates an alternate embodiment, in which the pyrolysis oil feed line 35 does not pass through the interior refractory lining 89. As shown, the pyrolysis oil feed line 35 does pass through the vessel wall 88 and terminates at pyrolysis oil outlet 36. The pyrolysis oil outlet 36 is positioned within the interior refractory lining 89. As a result, the coolant outlet 86, which remains flush with the inner surface of the interior refractory lining 89, extends distally from the pyrolysis oil outlet 36. Thus, the pyrolysis oil stream 16 exits the pyrolysis oil outlet 36 as indicated by arrows 93 and is surrounded by the annular stream 92 of the coolant 82 within the coolant conduit 84 before passing out of the coolant outlet 86 of the coolant conduit 84. Optionally, the pyrolysis oil outlet 36 may be positioned outside of the vessel wall 88.

In the exemplary embodiments of FIGS. 2 and 3, active cooling is conducted by externally cooling the pyrolysis oil stream 16 with the coolant 82. Additionally, the pyrolysis oil stream 16 may be internally cooled with a supplemental component, indicated by arrow 98, that is added to the pyrolysis oil stream 16. The pyrolysis oil stream 16 can be internally cooled in combination with externally cooling the pyrolysis oil stream 16 to maintain the pyrolysis oil stream 16 at the temperature of less than or equal to about 160° C. substantially up to the pyrolysis oil outlet 36. In an embodiment, the pyrolysis oil stream 16 is internally cooled by adding the supplemental component 98 to the pyrolysis oil stream 16 that is flowing through the pyrolysis oil feed line 35. The supplemental component 98 can be, for example, a carrier gas that is added to the pyrolysis oil stream 16 to assist with introducing the pyrolysis oil stream 16 into the reaction zone 28. In this embodiment, the carrier gas and the pyrolysis oil stream 16 are mixed prior to introducing the pyrolysis oil stream 16 into the reaction zone 28 to also internally cool the pyrolysis oil stream 16. The carrier gas 52 may be FCC product gas (such as from gaseous component 60 in FIG. 1), steam, and/or an inert gas such as nitrogen. To cool the pyrolysis oil stream 16 with the supplemental component 98, the supplemental component 98 is provided at a temperature of less than or equal to about 160° C., such as less than or equal to about 110° C., or such as lower than about 50° C. Because carrier gas 98 is employed in relatively small amounts compared to the pyrolysis oil stream 16, under conditions in which the pyrolysis oil stream 16 is internally cooled with the carrier gas 98, the carrier gas 98 can be provided at temperatures that are substantially lower than 50° C., depending upon the particular type of carrier gas that is employed to effectuate cooling.

The coolant 82 may flow into the coolant conduit 84 from a coolant source (not shown), such as a gas compressor. Once in the coolant conduit 84, the coolant 82 flows through the annular portion of the coolant conduit 84 surrounding the pyrolysis oil feed line 35, in contact with the wall of the pyrolysis oil feed line 35. The coolant 82 contacts the outer wall of the pyrolysis oil feed line 35 and buffers the pyrolysis oil feed line 35 from exposure to external heat. Further, the coolant 82 enters the reaction chamber 28 as the annular stream 92 and, without being bound by any particular theory, it is believed that the annular stream 92 inhibits heating of the injected pyrolysis oil 93 after injection of the pyrolysis oil stream 16 into the reaction chamber 28 until the injected pyrolysis oil 93 has traveled away from the pyrolysis oil outlet 36. Specifically, after exiting the coolant outlet 86, it is believed that the coolant 82 draws heat from gases adjacent the coolant outlet 82 in the reaction zone 28, which heat may otherwise result in temperature rise of the injected pyrolysis oil 93 and stream 16, thereby minimizing temperature rise of the injected pyrolysis oil 93 and pyrolysis oil stream 16 that may otherwise occur.

While FIGS. 2 and 3 illustrate a single paired coolant conduit 84 and pyrolysis oil feed line 35, a plurality of paired coolant conduit 84 and pyrolysis oil feed line 35 may be utilized to introduce the pyrolysis oil stream 16 to the reaction zone 28. Further, additional coolant conduits 48 may be provided in the FCC unit 14, as shown in FIG. 1, to independently add coolant 82 to the reaction zone 28, i.e., without also adding pyrolysis oil.

As alluded to above, structure and function of the fuel processing apparatuses that are described herein are not limited by the manner in which the fuel processing apparatuses are operated. Specific process parameters such as flow rates of the coolant 82, inlet temperature of the coolant 82, contact surface area between the wall of the pyrolysis oil feed line 35 and the coolant 82, inner and outer diameters of the pyrolysis oil feed line 35 and the coolant conduit 84, coolant composition, and other considerations that pertain to maintaining the pyrolysis oil stream 16 at the temperature of less than or equal to about 100° C. substantially up to the pyrolysis oil outlet 36 are design considerations that can be readily determined by those of skill in the art.

Although the methods described herein are effective for minimizing deposit formation from the pyrolysis oil stream 16 prior to introducing the pyrolysis oil stream 16 into the reaction zone 28 independent of a ratio of the pyrolysis oil stream 16 to the hydrocarbon stream 20, excessive deposit formation on the particulate cracking catalyst 30 may be avoided by adjusting the ratio at which the pyrolysis oil stream 16 and the hydrocarbon stream 20 are mixed. In an embodiment, the pyrolysis oil stream 16 and the hydrocarbon stream 20 are mixed at a weight ratio of the pyrolysis oil stream 16 to the hydrocarbon stream 20 of from about 0.005:1 to about 0.2:1, such as from about 0.01:1 to about 0.05:1. Within the aforementioned weight ratios, the pyrolysis oil stream 16 is sufficiently dilute within the mixture 46 of the pyrolysis oil stream 16 and the hydrocarbon stream 20 to avoid excessive deposit formation on the particulate cracking catalyst 30, thereby avoiding impact on catalyst activity and selectivity of the particulate cracking catalyst 30 within the fluid catalytic cracking unit 14 or excessive heat generation in the catalyst regenerator 70.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A fluid catalytic cracking unit comprising:
a reaction chamber suitable for contacting a pyrolysis oil, a hydrocarbon, and a catalyst;
a coolant conduit having an coolant outlet in communication with the reaction chamber and suitable for introducing a coolant stream through the coolant outlet into the reaction chamber; and
a pyrolysis oil conduit positioned within the coolant conduit and suitable for injecting the pyrolysis oil through a pyrolysis oil outlet into the reaction chamber.

2. The fluid catalytic cracking unit of claim 1 wherein the pyrolysis oil outlet is about flush with the coolant outlet.

3. The fluid catalytic cracking unit of claim 1 wherein the coolant conduit extends distally from the pyrolysis oil outlet.

4. The fluid catalytic cracking unit of claim 1 wherein the pyrolysis oil outlet includes an injection nozzle.

5. The fluid catalytic cracking unit of claim 1 wherein the reaction chamber is bounded by a vessel wall with an interior refractory lining, wherein the coolant conduit extends through the vessel wall, and wherein the coolant outlet is about flush with an inner surface of the interior refractory lining.

6. The fluid catalytic cracking unit of claim 1 wherein the reaction chamber is bounded by a vessel wall with internal refractory, wherein the coolant conduit extends through the vessel wall and the coolant outlet is about flush with an inner surface of the internal refractory, and wherein the pyrolysis oil outlet is about flush with the inner surface of the internal refractory.

7. The fluid catalytic cracking unit of claim 1 wherein the coolant conduit is formed as an outer annular portion of a pipe and the pyrolysis oil conduit is formed as an inner portion of a pipe contained inside the annular portion, and wherein the coolant conduit extends distally from the pyrolysis oil outlet.

8. A fuel processing apparatus comprising:
a pyrolysis reactor for pyrolyzing a biomass stream to produce a pyrolysis oil; and
a fluid catalytic cracking unit comprising:
a reaction chamber suitable for contacting the pyrolysis oil, a hydrocarbon, and a catalyst;
a hydrocarbon conduit in communication with the reaction chamber and suitable for introducing the hydrocarbon into the reaction chamber; and
an annular pipe having an outer coolant conduit and an inner pyrolysis oil conduit positioned within the outer coolant conduit, wherein the outer coolant conduit is in communication with the reaction chamber and is suitable for introducing a coolant into the reaction chamber in a coolant stream, and wherein the inner pyrolysis oil conduit is suitable for injecting the pyrolysis oil into the coolant stream within the reaction chamber.

9. The fuel processing apparatus of claim 8 wherein the inner pyrolysis oil conduit terminates at a pyrolysis oil outlet positioned within the coolant conduit.

10. The fuel processing apparatus of claim 8 wherein the outer coolant conduit terminates at a coolant outlet, wherein the inner pyrolysis oil conduit terminates at a pyrolysis oil outlet, and wherein the pyrolysis oil outlet is about flush with the coolant outlet.

11. The fuel processing apparatus of claim 8 wherein the outer coolant conduit terminates at a coolant outlet, wherein the inner pyrolysis oil conduit terminates at a pyrolysis oil outlet, and wherein the outer coolant conduit extends distally from the pyrolysis oil outlet.

12. The fuel processing apparatus of claim 8 wherein the inner pyrolysis oil conduit terminates at a pyrolysis oil outlet formed as an injection nozzle.

13. The fuel processing apparatus of claim 8 wherein the reaction chamber is bounded by a vessel wall, wherein the outer coolant conduit extends through the vessel wall.

14. A method for processing a pyrolysis oil stream and a hydrocarbon stream, the method comprising the steps of:
introducing the hydrocarbon stream to a reaction zone;
introducing a stream of coolant into contact with the hydrocarbon stream within the reaction zone; and
injecting the pyrolysis oil stream into the stream of coolant within the reaction zone.

15. The method of claim 14 further comprising mixing the pyrolysis oil stream, the coolant and the hydrocarbon stream within the reaction zone.

16. The method of claim 14 further comprising:
mixing the pyrolysis oil stream, the coolant and the hydrocarbon stream within the reaction zone; and
maintaining the pyrolysis oil stream at a temperature of less than about 160° C. with the coolant before mixing the pyrolysis oil stream, the coolant and the hydrocarbon stream within the reaction zone.

17. The method of claim 14 wherein:
the reaction zone is bounded by a vessel wall,
introducing the stream of coolant into the hydrocarbon stream comprises introducing the stream of coolant through a coolant conduit passing through the vessel wall into the hydrocarbon stream; and
injecting the pyrolysis oil stream into the stream of coolant comprises injecting the pyrolysis oil stream through a pyrolysis oil conduit positioned within the coolant conduit.

18. The method of claim 14 wherein:
the reaction zone is bounded by a vessel wall,
introducing the stream of coolant into the hydrocarbon stream comprises introducing the stream of coolant through a coolant conduit passing through the vessel wall and through a coolant outlet within the reaction zone into the hydrocarbon stream;
injecting the pyrolysis oil stream into the stream of coolant comprises injecting the pyrolysis oil stream through a pyrolysis oil conduit positioned within the coolant conduit; and
the pyrolysis oil outlet is flush with the coolant outlet.

19. The method of claim 14 wherein:
the reaction zone is bounded by a vessel wall,
introducing the stream of coolant into the hydrocarbon stream comprises introducing the stream of coolant through a coolant conduit passing through the vessel wall and through a coolant outlet within the reaction zone into the hydrocarbon stream;
injecting the pyrolysis oil stream into the stream of coolant comprises injecting the pyrolysis oil stream through a pyrolysis oil conduit positioned within the coolant conduit and through a pyrolysis oil outlet positioned in the coolant conduit; and
the coolant conduit extends distally from the pyrolysis oil outlet.

20. The method of claim 14 wherein the reaction zone is formed in a fluid catalytic cracking (FCC) unit and wherein the method further comprises:
forming an FCC product gas in the FCC unit; and
recycling the FCC product gas for use as the stream of coolant or for use as a carrier gas introduced into the pyrolysis oil stream before injecting the pyrolysis oil stream into the stream of coolant within the reaction zone.
